(19) United States
(12) Patent Application Publication
(10) Pub. No.: US 2015/0268899 A1
(43) Pub. Date: Sep. 24, 2015

(54) CONTROL APPARATUS, INFORMATION PROCESSING APPARATUS, AND INFORMATION PROCESSING SYSTEM

(71) Applicant: FUJI XEROX CO., LTD., Tokyo (JP)

(72) Inventor: Jun SATO, Kanagawa (JP)

(21) Appl. No.: 14/567,059

(22) Filed: Dec. 11, 2014

(30) Foreign Application Priority Data
Mar. 20, 2014 (JP) 2014-057846

(51) Int. Cl. G06F 3/12

(52) U.S. Cl. CPC G06F 3/1221; G06F 3/1229; G06F 3/1285

(57) ABSTRACT

A control apparatus includes a first communication interface that is connected to a first communication line and performs communication via the first communication line, a second communication interface that is connected to a second communication line and performs communication via the second communication line, a power supplying unit that, in a first operational state, supplies power to the first and second communication interfaces and that, in a second operational state in which power consumption is lower than that in the first operational state, supplies power only to the second communication interface, and a switching unit that performs switching from the second operational state to the first operational state if, in the second operational state, a request for shifting to the first operational state is transmitted from a client apparatus connected to the first communication line to the second communication interface via the first and second communication lines.

### CROSS-REFERENCE TO RELATED APPLICATIONS

This application is based on and claims priority under 35 USC 119 from Japanese Patent Application No. 2014-057846 filed Mar. 20, 2014.

### BACKGROUND

(i) Technical Field

The present invention relates to a control apparatus, an information processing apparatus, and an information processing system.

(ii) Related Art

In many information processing apparatuses that perform information processing such as image processing, an operation mode (a so-called “sleep mode”) is available in which power consumption is reduced by restricting some functions.

### SUMMARY

According to an aspect of the invention, there is provided a control apparatus including: a first communication interface that is connected to a first communication line and performs communication via the first communication line; a second communication interface that is connected to a second communication line and performs communication via the second communication line; a power supplying unit that, in a first operational state, supplies power to the first communication interface and the second communication interface and that, in a second operational state in which power consumption is lower than power consumption in the first operational state, does not supply power to the first communication interface but supplies power to the second communication interface; and a switching unit that performs switching from the second operational state to the first operational state if, in the second operational state, a request for shifting to the first operational state is transmitted from a client apparatus connected to the first communication line to the second communication interface via the first communication line and the second communication line.

### BRIEF DESCRIPTION OF THE DRAWINGS

An exemplary embodiment of the present invention will be described in detail based on the following figures, wherein:

FIG. 1 is a block diagram illustrating the configuration of an information processing system according to an exemplary embodiment of the present invention;

FIG. 2 is a block diagram illustrating the configuration of an image forming apparatus according to the exemplary embodiment;

FIG. 3 illustrates an example of information stored in the image forming apparatus;

FIG. 4 illustrates an example of operations in the information processing system;

FIG. 5 illustrates an example of information transmitted from the image forming apparatus to a client apparatus;

FIGS. 6A and 6B illustrate examples of operations in the information processing system;

FIG. 7 illustrates an example of operations in the information processing system;

FIG. 8 illustrates an example of operations in the information processing system;

FIG. 9 illustrates an example of operations in the information processing system;

FIG. 10 illustrates an example of operations in the information processing system; and

FIG. 11 illustrates an example of operations in an information processing system according to a modification.

### DETAILED DESCRIPTION

### Exemplary Embodiment

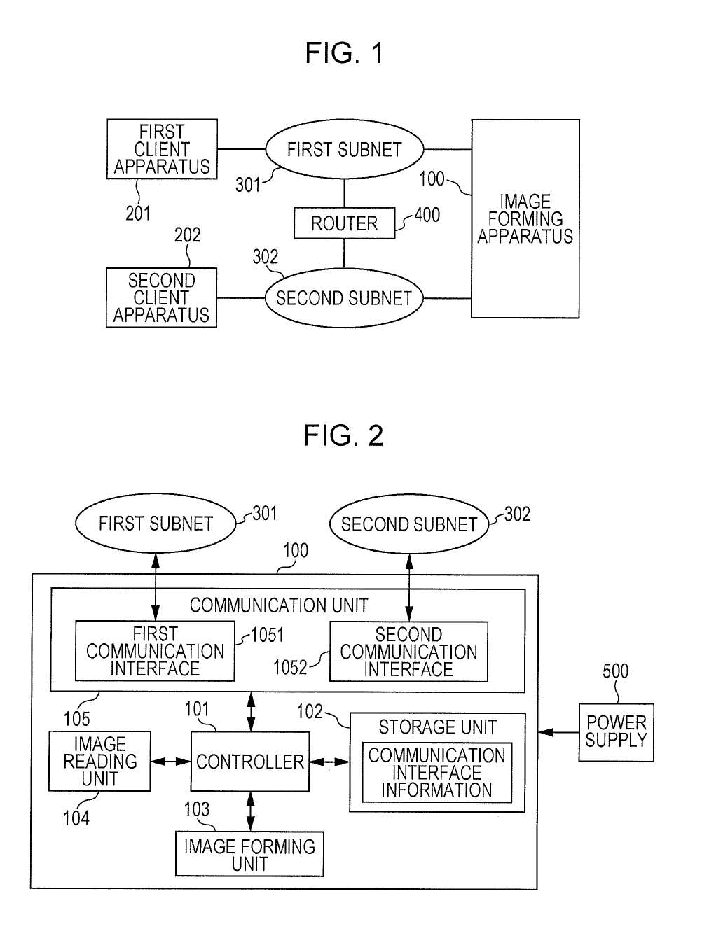

Hereinafter, an exemplary embodiment of the present invention will be described. FIG. 1 is a block diagram illustrating the configuration of an information processing system according to the exemplary embodiment of the present invention. The information processing system includes an image forming apparatus 100, one or more first client apparatuses 201 (only one illustrated in FIG. 1) connected to the image forming apparatus 100 via a first subnet 301, one or more second client apparatuses 202 (only one illustrated in FIG. 1) connected to the image forming apparatus 100 via a second subnet 302, and a router 400 that connects the first subnet 301 and the second subnet 302 to each other. The image forming apparatus 100 is an example of an image processing apparatus. The first client apparatus 201 and the second client apparatus 202 are examples of a client apparatus. The first subnet 301 is an example of a first communication line. The second subnet 302 is an example of a second communication line. The router 400 is an example of a relay apparatus. Note that the number of subnets and the number of client apparatuses are not limited to those illustrated in FIG. 1, and there may be three or more subnets.

The image forming apparatus 100 has functions for printing, copying, and facsimile transmission, for example. The first client apparatus 201 and the second client apparatus 202 are personal computers that are used by users at their desks, for example. The image forming apparatus 100 receives image data transmitted from the first client apparatus 201 via the first subnet 301 and performs processing for forming an image corresponding to the image data, or receives image data transmitted from the second client apparatus 202 via the second subnet 302 and performs processing for forming an image corresponding to the image data. The processing for forming an image is hereinafter referred to as “printing”.

The first subnet 301 and the second subnet 302 are used by respective user groups with different attributes. It is assumed here that the first subnet 301 is installed in a department such as a sales department of a company where there is a specific time during business hours (weekday morning and evening when sales staff are in the office) in which printing is frequently performed, and that the second subnet 302 is installed in a department such as an administration department of the company where there is not a specific time during business hours in which printing is frequently performed. The first subnet 301 and the second subnet 302 are provided separately in this way in order to prevent image data from being exchanged between these departments in view of preventing information leakage.

Therefore, as for data transmitted in accordance with a printing protocol such as the Line Printer Daemon protocol (LPR), the router 400 does not perform relay between the first subnet 301 and the second subnet 302. That is, the router 400 neither relays to the second subnet 302 image data that is transmitted over the first subnet 301 in accordance with the printing protocol, nor relays to the first subnet 301 image data that is transmitted over the second subnet 302 in accordance with the printing protocol. However, as for data transmitted in accordance with a specific protocol such as the Hypertext Transfer Protocol (HTTP) that is different from printing protocols, the router 400 relays the data between the first subnet 301 and the second subnet 302.

FIG. 2 is a block diagram illustrating the configuration of the image forming apparatus 100. The image forming apparatus 100 includes a controller 101, a storage unit 102, an image forming unit 103, an image reading unit 104, and a communication unit 105. The image forming apparatus 100 is supplied with power from a power supply 500 such as a commercial power supply. The controller 101 includes control circuits such as an application specific integrated circuit (ASIC) and a central processing unit (CPU), and various types of memories. The storage unit 102 is, for example, a hard disk, and stores programs executed by the CPU and communication interface information described below. The image forming unit 103 irradiates an image carrier such as a photoconductor with laser beams so as to form a latent image, develops the latent image with toners of different colors of yellow (Y), magenta (M), cyan (C), and black (K), transfers the image to a recording sheet, performs fixing processing, and outputs the recording sheet. The image reading unit 104 optically reads a document. The communication unit 105 includes the same number of communication interfaces as the number of subnets included in the information processing system. In FIG. 2, the communication unit 105 includes a first communication interface 1051 connected to the first subnet 301, and a second communication interface 1052 connected to the second subnet 302.

The operation mode of the communication unit 105 includes a normal mode (an example of a first operational state) and a power-saving mode (an example of a second operational state) in which power consumption is lower than that in the normal mode. The normal mode is an example of the first operational state, and the power-saving mode is an example of the second operational state. The controller 101 performs switching from the normal mode to the power-saving mode when a predetermined mode shift condition is satisfied in the normal mode, and performs switching from the power-saving mode to the normal mode (performs processing for returning to the normal mode) when the predetermined mode shift condition is not satisfied in the power-saving mode. That is, the controller 101 is an example of a switching unit that performs switching between the first operational state and the second operational state.

In the power-saving mode, the controller 101 does not supply power to one of the communication interfaces of the communication unit 105. In this example, in the power-saving mode, the controller 101 does not supply power to the first communication interface 1051 connected to the first subnet 301, but maintains power supply to the second communication interface 1052 connected to the second subnet 302. That is, the controller 101 is an example of a power supplying unit that, in the first operational state (normal mode), supplies power to the first communication interface and the second communication interface and that, in the second operational state (power-saving mode) in which power consumption is lower than that in the first operational state (normal mode), does not supply power to the first communication interface but supplies power to the second communication interface.

As mentioned above, as for the first subnet 301, there is a specific time during which printing is frequently performed. On the other hand, as for the second subnet 302, there is not a specific time during which printing is frequently performed. Therefore, in order to reduce occurrence of a situation in which, when the user wishes to perform printing, it is not possible to perform printing due to no power being supplied to the communication interface, it is more appropriate to stop power supply to the first communication interface 1051 than to stop power supply to the second communication interface 1052.

Accordingly, in the image forming apparatus 100, the second communication interface 1052 is set in advance as a communication interface to be supplied with power even in the power-saving mode and to be used also for returning from the power-saving mode to the normal mode. The communication interface to be used also for returning from the power-saving mode to the normal mode as described above is called a “communication interface for returning from power saving”.

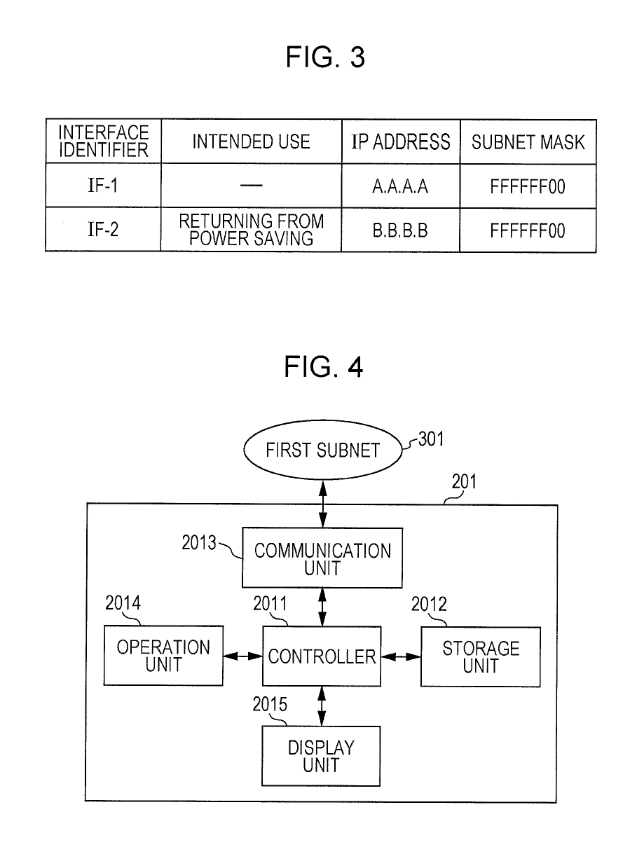

FIG. 3 illustrates an example of communication interface information stored in the storage unit 102 of the image forming apparatus 100. The communication interface information is information on the first communication interface 1051 and the second communication interface 1052, and includes an interface identifier, intended use, an Internet Protocol (IP) address, and a subnet mask. The interface identifier is an identifier assigned to each of the first communication interface 1051 and the second communication interface 1052. The intended use is information indicating whether each communication interface is a communication interface for returning from power saving. The IP address is an IP address assigned to each of the first communication interface 1051 and the second communication interface 1052. Generally, an IP address includes an address (network address) assigned to the subnet and an address (host address) assigned to a node in the subnet. The subnet mask is a value indicating the number of higher-order bits in the IP address assigned to each of the first communication interface 1051 and the second communication interface 1052 that correspond to the network address.

FIG. 4 is a block diagram illustrating the configuration of the first client apparatus 201 as the configuration of a client apparatus. The first client apparatus 201 includes a controller 2011, a storage unit 2012, a communication unit 2013, an operation unit 2014, and a display unit 2015. The controller 2011 includes a control circuit such as a CPU, and various types of memories. The storage unit 2012 is, for example, a hard disk, and stores various types of data and programs (such as a printer driver). The communication unit 2013 is connected to the first subnet 301 and performs communication via the first subnet 301. The operation unit 2014 includes operators such as keys, and supplies an operation signal corresponding to an operation performed by the user to the controller 2011. The display unit 2015 includes, for example, a liquid crystal panel and a drive circuit, and displays an image under the control of the controller 2011. The second client apparatus 202 has the same configuration as that of the first client apparatus 201 except that the subnet connected to its communication unit is the second subnet 302.

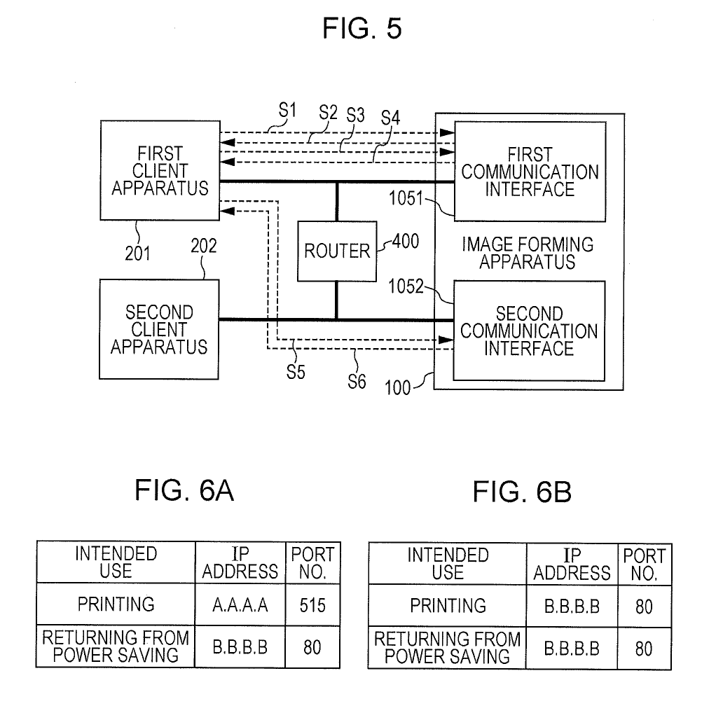

FIG. 5 illustrates operations performed when adding a new image forming apparatus to the printer driver in the first client apparatus 201. The controller 2011 of the first client apparatus 201 searches for an image forming apparatus connected to the first subnet 301 to which the first client apparatus 201 is connected in accordance with a protocol such as the Simple Network Management Protocol (SNMP), in response to a user operation or the like (step S1). Then, when there is a response from the controller 101 of the image forming apparatus 100 to the first client apparatus 201 (step S2), the controller 2011 of the first client apparatus 201 requests the image forming apparatus 100 for information on the image forming apparatus 100 (step S3).

In response to this request, the controller 101 of the image forming apparatus 100 transmits the intended use and IP address included in the communication interface information of FIG. 3, together with function information indicating functions of the image forming apparatus 100, such as the setting of the paper tray and the presence or absence of a so-called post-processing apparatus, to the first client apparatus 201 (step S4). That is, the controller 101 is an example of a transmitting unit that transmits information on the first communication interface and the second communication interface, in response to a request transmitted via the first communication interface or the second communication interface.

The controller 2011 of the first client apparatus 201 transmits an HTTP request to the IP address of the second communication interface 1052 that is indicated to be used for returning from power saving in the received communication interface information. Since this request is transmitted over a protocol called the HTTP that passes through the router 400, the request is relayed from the first subnet 301 to the second subnet 302 by the router 400, and is received by the second communication interface 1052 of the image forming apparatus 100 (step S5).

In response to the HTTP request, the controller 101 of the image forming apparatus 100 transmits an HTTP response via the second communication interface 1052. Since this response is also transmitted over a protocol called the HTTP that passes through the router 400, the response is relayed from the second subnet 302 to the first subnet 301 by the router 400, and is received by the first communication interface 1051 of the image forming apparatus 100 (step S6). Thus, the controller 2011 of the first client apparatus 201 confirms that communication with the second communication interface 1052 that serves as a communication interface for returning from power saving for the image forming apparatus 100 is possible.

FIG. 6A illustrates an example of information that is acquired by the controller 2011 of the first client apparatus 201 through the operations of FIG. 5 and is stored in the storage unit 2012. The information includes the intended use, the IP address, and the port number of each communication interface. The port number is a port number used in each of the first communication interface 1051 and the second communication interface 1052. For the first client apparatus 201, the first communication interface 1051 belonging to the same first subnet 301 is a communication interface for printing (IP address A.A.A.A). That is, in the case where the communication interface for printing is a communication interface that is not supplied with power in the power-saving mode, as illustrated in FIG. 6A, the IP address and port number of the communication interface for printing are different from those of the communication interface for returning from power saving. This is because it is not possible to use the communication interface for printing in the power-saving mode, and therefore another interface, that is, the communication interface for returning from power saving is needed in order to use the communication interface for printing.

FIG. 6B illustrates an example of information that is acquired by the controller of the second client apparatus 202 through the operations of FIG. 5 and is stored in the storage unit. For the second client apparatus 202, the second communication interface 1052 belonging to the same second subnet 302 is a communication interface for printing (IP address B.B.B.B). In this case, the communication interface for printing is a communication interface that is supplied with power in the power-saving mode. Thus, as illustrated in FIG. 6B, the IP address and port number of the communication interface for printing are the same as those of the communication interface for returning from power saving.

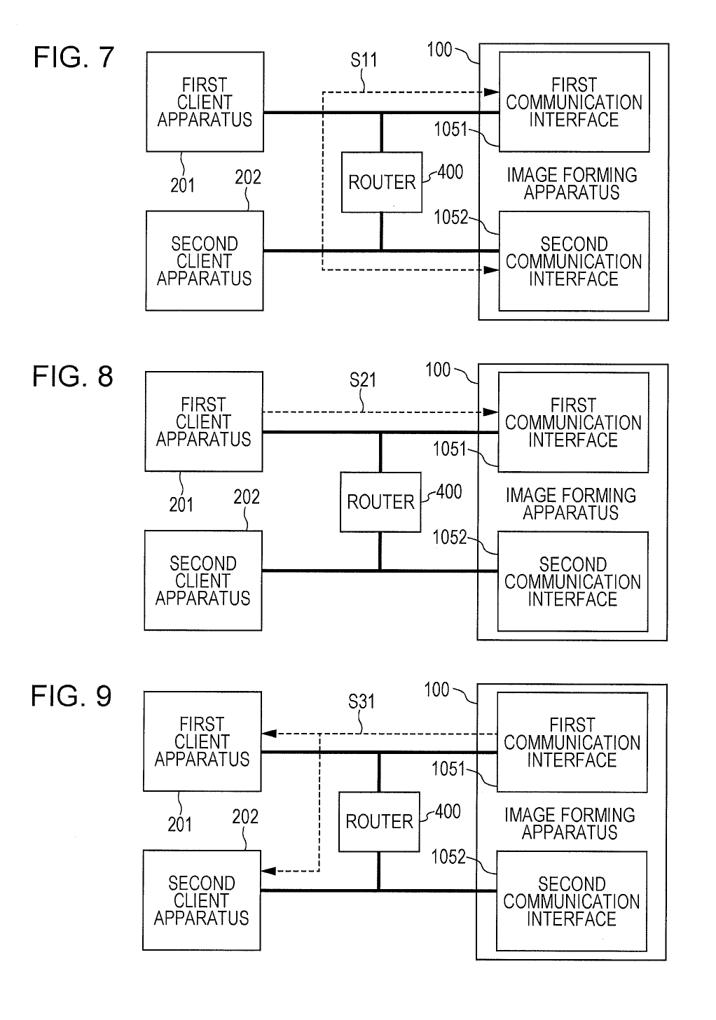

FIG. 7 illustrates an existence determination process performed between the first communication interface 1051 and the second communication interface 1052. The first communication interface 1051 and the second communication interface 1052 determine whether communication therebetween is possible, using ping or the like, at a predetermined time such as when starting the image forming apparatus 100 (step S11). Thus, it is possible to determine that communication via the router 400 is possible between the first subnet 301 and the second subnet 302 connected to the respective first communication interface 1051 and second communication interface 1052. That is, the controller 101 is an example of a determining unit that determines whether communication via the first communication line and the second communication line is possible between the first communication interface and the second communication interface. In the case where the communication is possible, the controller 101 performs shifting from the normal mode to the power-saving mode if the mode shift condition is satisfied later on. On the other hand, in the case where the communication is not possible, even if the mode shift condition is satisfied later on, the controller 101 does not perform shifting from the normal mode to the power-saving mode, and maintains power supply to both the first communication interface 1051 and the second communication interface 1052. That is, if the determining unit determines that the communication is possible, the controller 101 as an example of the switching unit performs switching from the first operational state to the second operational state.

FIG. 8 illustrates operations performed when the first client apparatus 201 instructs the image forming apparatus 100 to perform printing in the normal mode. The controller 2011 of the first client apparatus 201 refers to the IP address and port number of the first communication interface 1051 that is indicated to be used for printing in FIG. 6A, and transmits a print instruction and image data to the first communication interface 1051 in accordance with the LPR (step S21). Having received the print instruction and the image data via the first communication interface 1051, the controller 101 of the image forming apparatus 100 performs processing for forming an image corresponding to the image data. That is, the controller 101 is an example of a processing unit that performs processing corresponding to data transmitted from the first client apparatus to the first communication interface that is supplied with power upon switching to the first operational state.

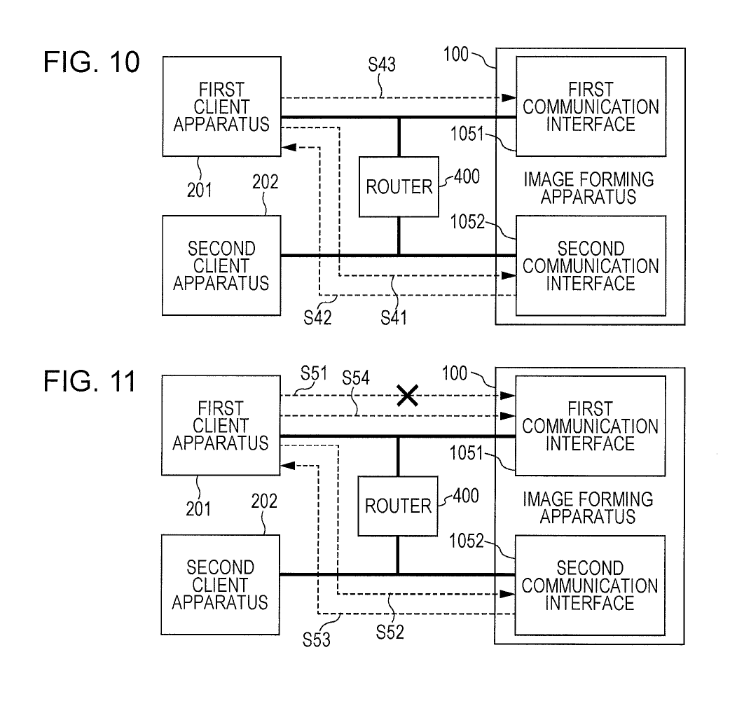

FIGS. 9 and 10 illustrate operations performed when the first client apparatus 201 instructs the image forming apparatus 100 to perform printing in the power-saving mode. When the mode shift condition is satisfied, the controller 101 of the image forming apparatus 100 transmits a power-saving mode shift notice from the first communication interface 1051 that is to be subject to power saving, before shifting to the power-saving mode. The power-saving mode shift notice is received by the first client apparatus 201 via the first subnet 301, and is also received by the second client apparatus 202 via the first subnet 301 and the second subnet 302 (step S31 of FIG. 9).

Thereafter, when instructing the image forming apparatus 100 to perform printing, the controller 2011 of the first client apparatus 201 refers to the IP address and port number of the second communication interface 1052 that is indicated to be used for returning from power saving in FIG. 6A, and transmits a return request for returning from the power-saving mode to the normal mode to the second communication interface 1052 in accordance with the HTTP (step S41). Having received the return request via the second communication interface 1052, the controller 101 of the image forming apparatus 100 first determines which of the first subnet 301 and the second subnet 302 the client apparatus that has made the return request belongs to, on the basis of the IP address of the source of the return request and the IP address and subnet mask of each communication interface illustrated in FIG. 3. In this example, the IP address of the source of the return request is masked by the subnet mask of each of the communication interface of FIG. 3 and is compared to the IP address of each communication interface. Thus, the client apparatus that has made the return request is determined to belong to the first subnet 301. That is, in this example, the controller 2011 determines that the communication interface to be returned from the power-saving mode to the normal mode is the first communication interface 1051 belonging to the first subnet 301.

Then, the controller 2011 calculates the period of time required to return the determined communication interface from the power-saving mode to the normal mode, and reports the time period from the second communication interface 1052 to the first client apparatus 201 (step S42). Then, the controller 101 performs switching from the power-saving mode to the normal mode. That is, the controller 101 as an example of the switching unit that performs switching from the second operational state to the first operational state if, in the second operational state, a request for shifting to the first operation mode is transmitted from the client apparatus connected to the first communication line to the second communication interface via the first communication line and the second communication line.

When the period of time reported from the image forming apparatus 100 elapses, the controller 2011 of the first client apparatus 201 refers to the IP address and port number of the first communication interface 1051 that is indicated to be used for printing in FIG. 6A, and transmits a print instruction and image data to the first communication interface 1051 in accordance with the LPR (step S43). Having received the print instruction and the image data via the first communication interface 1051, the controller 101 of the image forming apparatus 100 performs processing for forming an image corresponding to the image data. In this way, on the basis of the interface information on the first communication interface and the second communication interface transmitted from the image forming apparatus as an example of the information processing apparatus, the first client apparatus 201 transmits a request for shifting to the first operational state to the second communication interface via the first communication line and the second communication line when the image forming apparatus is in the second operational state, and transmits a request for processing to the first communication interface via the first communication line when the image forming apparatus is switched to the first operational state.

### Modifications

### Modification 1

FIG. 11 illustrates another example of operations performed when the first client apparatus 201 instructs the image forming apparatus 100 to perform printing in the power-saving mode. In this example, a power-saving mode shift notice is not transmitted from the image forming apparatus 100 to each client apparatus, before the image forming apparatus 100 shifts to the power-saving mode. When instructing the image forming apparatus 100 to perform printing, the controller 2011 of the first client apparatus 201 refers to the IP address and port number of the first communication interface 1051 that is indicated to be used for printing in FIG. 6A, and transmits a print instruction and image data to the first communication interface 1051 in accordance with the LPR. However, since the first communication interface 1051 is not supplied with power, a communication error occurs (step S51).

If such a communication error occurs, the controller 2011 of the first client apparatus 201 refers to the IP address and port number of the second communication interface 1052 that is indicated to be used for returning from power saving in FIG. 6A, and transmits a return request to the second communication interface 1052 in accordance with the HTTP (step S52). Having received the return request via the second communication interface 1052, the controller 101 of the image forming apparatus 100 reports the period of time required to return to the normal mode from the second communication interface 1052 to the first client apparatus 201 (step S53). Then, the controller 101 performs processing for returning from the power-saving mode to the normal mode.

When the period of time reported from the image forming apparatus 100 elapses, the controller 2011 of the first client apparatus 201 refers to the IP address and port number of the first communication interface 1051 that is indicated to be used for printing in FIG. 6A, and transmits a print instruction and image data to the first communication interface 1051 in accordance with the LPR (step S54). Having received the print instruction and the image data via the first communication interface 1051, the controller 101 of the image forming apparatus 100 performs processing for forming an image corresponding to the image data.

### Modification 2

In step S5 of FIG. 5, if the first client apparatus 201 is not able to communicate with the communication interface for returning from power saving, the first client apparatus 201 may display a warning indicating that it is not possible to perform printing in the power-saving mode on the display unit 2015.

### Modification 3

In the exemplary embodiment, the intended use of each communication interface illustrated in FIG. 3 is determined in advance. However, the image forming apparatus 100 may dynamically determine the intended use. More specifically, the controller 101 stores, in the storage unit 102, the date and time of print instructions that are received via each communication interface during a certain period, and calculates the degree of temporal concentration of print instructions on the basis of the temporal distribution of print instructions received via each communication interface. Then, the controller 101 determines that the communication interface with a lower degree of temporal concentration is to be used for returning from power saving.

### Modification 4

The present invention may be provided in the form of a program for causing a computer to function as a control apparatus or an information processing apparatus, or a computer-readable medium storing the program. The program according to an exemplary embodiment of the present invention may be downloaded to a computer over a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control apparatus comprising:
a first communication interface that is connected to a first communication line and performs communication via the first communication line;
a second communication interface that is connected to a second communication line and performs communication via the second communication line;
a power supplying unit that, in a first operational state, supplies power to the first communication interface and the second communication interface and that, in a second operational state in which power consumption is lower than power consumption in the first operational state, does not supply power to the first communication interface but supplies power to the second communication interface; and
a switching unit that performs switching from the second operational state to the first operational state if, in the second operational state, a request for shifting to the first operational state is transmitted from a client apparatus connected to the first communication line to the second communication interface via the first communication line and the second communication line.

2. The control apparatus according to claim 1, further comprising:
a determining unit that determines whether communication via the first communication line and the second communication line is possible between the first communication interface and the second communication interface;
wherein the switching unit performs switching from the first operational state to the second operational sate if the determining unit determines that the communication is possible.

3. The control apparatus according to claim 1, further comprising:
a transmitting unit that transmits communication interface information on the first communication interface and the second communication interface, in response to a request transmitted to the first communication interface or the second communication interface from a client apparatus.

4. An information processing apparatus comprising:
the control apparatus of claim 1; and
a processing unit that performs processing corresponding to data transmitted from the client apparatus to the first communication interface that is supplied with power upon switching to the first operational state.

5. The information processing apparatus according to claim 4, wherein the processing unit performs processing of forming an image corresponding to image data transmitted from the client apparatus to the first communication interface that is supplied with power upon switching to the first operational state.

6. An information processing system comprising:
a relay apparatus that is connected to a first communication line and a second communication line and relays only communication which uses a specific protocol between the first communication line and the second communication line;
a first client apparatus connected to the first communication line;
a second client apparatus connected to the second communication line; and
an information processing apparatus that includes
a first communication interface that is connected to the first communication line and performs communication via the first communication line,
a second communication interface that is connected to the second communication line and performs communication via the second communication line,
a power supplying unit that, in a first operational state, supplies power to the first communication interface and the second communication interface and that, in a second operational state in which power consumption is lower than power consumption in the first operational state, does not supply power to the first communication interface but supplies power to the second communication interface,
a switching unit that performs switching from the second operational state to the first operational state if, in the second operational state, a request for shifting to the first operational state is transmitted from the first client apparatus to the second communication interface via the first communication line and the second communication line, and
a processing unit that performs processing corresponding to data transmitted from the first client apparatus to the first communication interface that is supplied with power upon switching to the first operational state.
